(19) United States
(12) Patent Application Publication
(10) Pub. No.: US 2023/0025015 A1
(43) Pub. Date: Jan. 26, 2023

(54) METHODS AND APPARATUS TO FACILITATE CONTENT GENERATION FOR CLOUD COMPUTING PLATFORMS

(71) Applicant: VMware, Inc., Palo Alto, CA (US)

(72) Inventors: Grigor Lechev, Sofia (BG); Kostadin Samardzhiev, Sofia (BG)

(21) Appl. No.: 17/384,462

(22) Filed: Jul. 23, 2021

(51) Int. Cl. G06F 9/455; G06F 9/50; G06F 8/656

(52) U.S. Cl. CPC G06F 9/45558; G06F 9/5072; G06F 8/656; G06F 2009/4557; G06F 2009/45583

(57) ABSTRACT

Methods, apparatus, systems, and articles of manufacture are disclosed to facilitate content generation for cloud computing platforms. An example apparatus includes model definition circuitry to generate model definitions representative of one or more undefined target system objects in a target system, and generate instructions that cause a developer environment to provide the model definitions during a generation of content files, generation order circuitry to generate a processing order of the content files, the content files having one or more defined model objects, and object processing circuitry to convert the one or more defined model objects to defined target system objects for deployment and execution at the target system.

### FIELD OF THE DISCLOSURE

This disclosure relates generally to cloud computing platforms and, more particularly, to methods and apparatus to facilitate content generation for cloud computing platforms.

### BACKGROUND

Virtualizing computer systems provides benefits such as the ability to execute multiple computer systems on a single hardware computer, replicating computer systems, moving computer systems among multiple hardware computers, and so forth. “Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale.

### BRIEF DESCRIPTION OF THE DRAWINGS

FIG. 1 is an example architecture in which an example virtual imaging appliance (VIA) is utilized to configure and deploy an example virtual server rack.

FIG. 2 is a block diagram of an example content generation tool of FIG. 1 to process content for a target system.

FIG. 3 is an example digital folder including labelled content files stored at the example content generation tool of FIGS. 1 and 2.

FIG. 4 is a block diagram of an example operation of the content generation tool of FIGS. 1 and 2 to process content for the target system.

FIGS. 5-6 are flowcharts representative of example machine readable instructions that may be executed by example processor circuitry to implement the content generation tool of FIGS. 1 and 2 to facilitate content generation and process content for the target system.

FIG. 7 is a block diagram of an example processing platform including processor circuitry structured to execute the example machine readable instructions of FIGS. 5-6 to implement the content generation tool of FIGS. 1 and 2 to process content for the target system.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions of FIGS. 5-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Virtual cloud computing uses networks of remote servers, computers and/or computer programs to manage access to centralized resources and/or services, to store, manage, and/or process data. Virtual cloud computing enables businesses and large organizations to scale up IT requirements as demand or business needs increase. Virtual cloud computing relies on sharing resources to achieve coherence and economies of scale over a network. In some example cloud computing environments, an organization may store sensitive client data in-house on a private cloud application, but interconnect to a business intelligence application provided on a public cloud software service. In such examples, a cloud may extend capabilities of an enterprise, for example, to deliver a specific business service through the addition of externally available public cloud services. In some examples, cloud computing permits multiple users to access a single server to retrieve and/or update data without purchasing licenses for different applications.

Prior to cloud computing, as resources and data increased based on increased business needs or demands, computing systems required the addition of significantly more data storage infrastructure. Virtual cloud computing accommodates increases in workflows and data storage demands without significant efforts of adding more hardware infrastructure. For example, businesses may scale data storage allocation in a cloud without purchasing additional infrastructure.

Cloud computing comprises a plurality of key characteristics. First, cloud computing allows software to access application programmable interfaces (APIs) that enable machines to interact with cloud software in the same way that a traditional user interface (e.g., a computer desktop) facilitates interaction between humans and computers. Second, cloud computing enables businesses or large organizations to allocate expenses on an operational basis (e.g., on a per-use basis) rather than a capital basis (e.g., equipment purchases). Costs of operating a business using, for example, cloud computing, are not significantly based on purchasing fixed assets but are instead more based on maintenance of existing infrastructure. Third, cloud computing enables convenient maintenance procedures because computing applications are not installed on individual users' computers but are instead installed at one or more servers forming the cloud service. As such, software can be accessed and maintained from different places (e.g., from an example virtual cloud).

Information technology (IT) is the application of computers and telecommunications equipment to store, retrieve, transmit and/or manipulate data, often in the context of a business or other enterprise. For example, databases store large amounts of data to enable quick and accurate information storage and retrieval. IT service management refers to the activities (e.g., directed by policies, organized and structured in processes and supporting procedures) that are performed by an organization or part of an organization to plan, deliver, operate and control IT services that meet the needs of customers. IT management may, for example, be performed by an IT service provider through a mix of people, processes, and information technology. In some examples, an IT system administrator is a person responsible for the upkeep, configuration, and reliable operation of computer systems; especially multi-user computers, such as servers that seek to ensure uptime, performance, resources, and security of computers meet user needs. For example, an IT system administrator may acquire, install and/or upgrade computer components and software, provide routine automation, maintain security policies, troubleshoot technical issues, and provide assistance to users in an IT network. An enlarged user group and a large number of service requests can quickly overload system administrators and prevent immediate troubleshooting and service provisioning.

Cloud provisioning is the allocation of cloud provider resources to a customer when a cloud provider accepts a request from a customer. For example, the cloud provider creates a corresponding number of virtual machines and allocates resources (e.g., application servers, load balancers, network storage, databases, firewalls, IP addresses, virtual or local area networks, etc.) to support application operation. In some examples, a virtual machine is an emulation of a particular computer system that operates based on a particular computer architecture, while functioning as a real or hypothetical computer. Virtual machine implementations may involve specialized hardware, software, or a combination of both. Example virtual machines allow multiple operating system environments to co-exist on the same primary hard drive and support application provisioning. Before example virtual machines and/or resources are provisioned to users, cloud operators and/or administrators determine which virtual machines and/or resources should be provisioned to support applications requested by users.

Infrastructure-as-a-Service (also commonly referred to as IaaS) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

Applications (e.g., comprising a plurality of content) are typically developed with a multi-tier architecture in which functions such as presentation, application processing, and data management are logically separate components. For example, an enterprise's custom banking application that has a multi-tier architecture may use a cluster of application servers (e.g., JBoss Application Servers) to execute in a scalable runtime environment, a relational database management system (e.g., MySQL) to store account data, and a load balancer to distribute network traffic for robustness. Such a multi-tier application may include a plurality of different content generated by developer environments, such as integrated development environments (IDEs). The plurality of different content may include components that are reusable. For example, a cloud computing platform having multiple services may be able to reuse content from one service in a different service. However, different services provide different and/or unique implementations and integration with source code management/version control that is inconsistent with implementations of other services. Therefore, content developed for one service may not be easy to reuse in a different service. For example, an object made of custom data may require multiple revisions before that object can be implemented by and integrated with a different service. In some examples, the object requires special integration and editing for a different service of the cloud computing platform to be able to process, run, and/or execute the object on the different service.

For example, current cloud computing platforms (e.g., vRealize Automation® system and/or a vRealize Operations® system developed and sold by VMware, Inc.) do not provide a unified solution to create content. As mentioned above, different micro-services of cloud computing platforms, such as vRealize Automation® micro-services, provide a unique implementation and integration with source code management/version control that is inconsistent with implementations of other cloud computing platform micro-services (e.g., vRealize Automation® micro-services). For example, different micro-services utilize different programming languages, such as YAML, JSON, etc., which may import data differently, export data differently, process data differently, etc. As such, cloud computing platforms require developers to edit, through a text editor (e.g., a type of computer program that edits plain text), the code created for different services during implementation in order to run and/or process the code. Once edited, the code is hard to reuse in another instance (e.g., when a developer desires to reuse parts of the content they created for the application in a different application, in different content, in different micro-services, etc.).

Examples disclosed herein provide a unified solution for content generation and implementation in cloud computing platforms. Examples disclosed herein include a content generation tool that generates and provides pre-defined blueprints and/or specifications for a plurality of different content types. The example content generation tool described herein processes and converts content into a form that the cloud computing platform can understand and process. The example content generation tool facilitates an environment that makes creating content for cloud computing platforms simpler and faster. For example, the content generation tool makes content easy to integrate (e.g., upload, export, etc.) with cloud computing platforms and its corresponding services. Examples disclosed herein enable a simple solution for software reusability, software extensibility, and software robustness. For example, developers can utilize the content generation tool for creating content, reusing parts of the created content for subsequent content, adding onto the created content, and reviewing the content.

As used herein, content makes up a core and material structure of an application. For example, cloud computing content may be virtual machine templates, blueprints, actions, pipelines, accounts, subscriptions, files (e.g., ISO images, etc.), etc., that are to be defined by a developer and appropriately edited for an application. As used herein, an application is a computer program, made up of plurality of content, that is designed to carry out a specific task. As described above, applications are typically developed with a multi-tier architecture in which functions are logically separate components, defined by the content of the application.

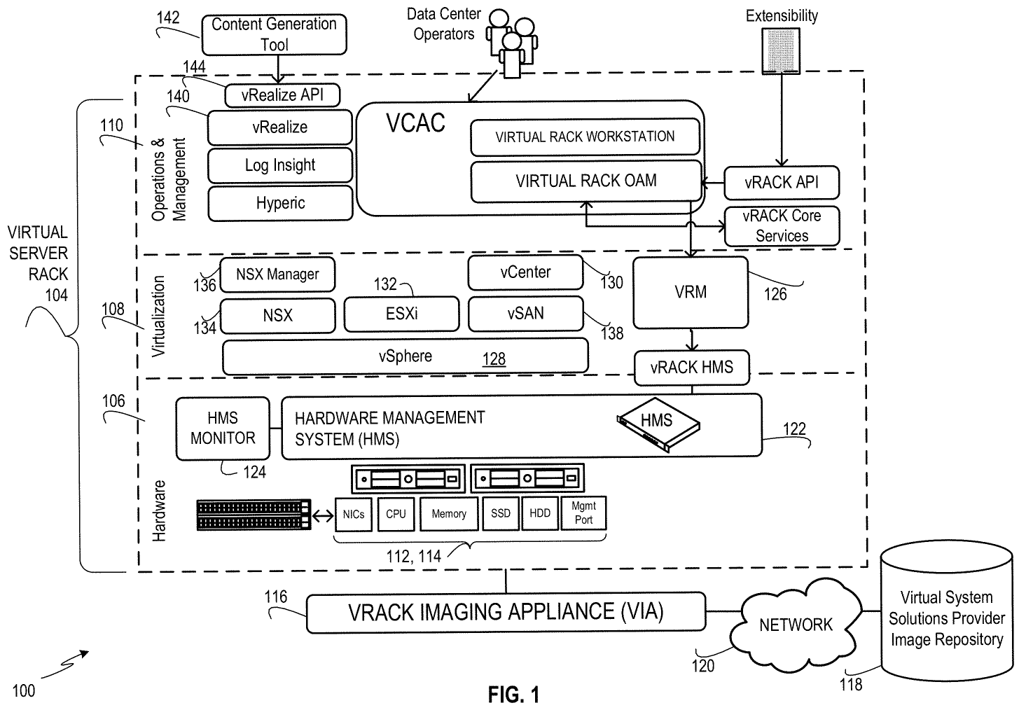

FIG. 1 is an example architecture 100 in which an example virtual imaging appliance (VIA) 102 is utilized to configure and deploy an example virtual server rack 104.

The example architecture 100 of FIG. 1 includes a hardware layer 106, a virtualization layer 108, and an operations and management component 110. In the illustrated example, the hardware layer 106, the virtualization layer 108, and the operations and management component 110 are part of the example virtual server rack 104. The virtual server rack 104 of the illustrated example is based on one or more example physical racks.

Example physical racks are a combination of computing hardware and installed software that may be utilized by a customer to create and/or add to a virtual computing environment. For example, the physical racks may include processing units (e.g., multiple blade servers), network switches to interconnect the processing units and to connect the physical racks with other computing units (e.g., other physical racks in a network environment such as a cloud computing environment), and/or data storage units (e.g., network attached storage, storage area network hardware, etc.). The example physical racks are prepared by the system integrator in a partially configured state to enable the computing devices to be rapidly deployed at a customer location (e.g., in less than 2 hours). For example, the system integrator may install operating systems, drivers, operations software, management software, etc. The installed components may be configured with some system details (e.g., system details to facilitate intercommunication between the components of two or more physical racks) and/or may be prepared with software to collect further information from the customer when the virtual server rack is installed and first powered on by the customer.

The example virtual server rack 104 is configured to configure example physical hardware resources 112, 114 (e.g., physical hardware resources of the one or more physical racks), to virtualize the physical hardware resources 112, 114 into virtual resources, to provision virtual resources for use in providing cloud-based services, and to maintain the physical hardware resources 112, 114 and the virtual resources. The example architecture 100 includes an example virtual imaging appliance (VIA) 116 that communicates with the hardware layer 106 to store operating system (OS) and software images in memory of the hardware layer 106 for use in initializing physical resources needed to configure the virtual server rack 104. In the illustrated example, the VIA 116 retrieves the OS and software images from a virtual system solutions provider image repository 118 via an example network 120 (e.g., the Internet). For example, the VIA 116 is to configure new physical racks for use as virtual server racks (e.g., the virtual server rack 104). That is, whenever a system integrator wishes to configure new hardware (e.g., a new physical rack) for use as a virtual server rack, the system integrator connects the VIA 116 to the new hardware, and the VIA 116 communicates with the virtual system provider image repository 118 to retrieve OS and/or software images needed to configure the new hardware for use as a virtual server rack. In the illustrated example, the OS and/or software images located in the virtual system provider image repository 118 are configured to provide the system integrator with flexibility in selecting to obtain hardware from any of a number of hardware manufacturers. As such, end users can source hardware from multiple hardware manufacturers without needing to develop custom software solutions for each hardware manufacturer. Further details of the example VIA 116 are disclosed in U.S. Patent Application Publication No. 2016/0013974, filed on Jun. 26, 2015, and titled “Methods and Apparatus for Rack Deployments for Virtual Computing Environments,” which is hereby incorporated herein by reference in its entirety.

The example hardware layer 106 of FIG. 1 includes an example hardware management system (HMS) 122 that interfaces with the physical hardware resources 112, 114 (e.g., processors, network interface cards, servers, switches, storage devices, peripherals, power supplies, etc.). The HMS 122 is configured to manage individual hardware nodes such as different ones of the physical hardware resources 112, 114. For example, managing of the hardware nodes involves discovering nodes, bootstrapping nodes, resetting nodes, processing hardware events (e.g., alarms, sensor data threshold triggers) and state changes, exposing hardware events and state changes to other resources and a stack of the virtual server rack 104 in a hardware-independent manner. The HMS 122 also supports rack-level boot-up sequencing of the physical hardware resources 112, 114 and provides services such as secure resets, remote resets, and/or hard resets of the physical hardware resources 112, 114.

In the illustrated example of FIG. 1, the hardware layer 106 includes an example HMS monitor 124 to monitor the operational status and health of the HMS 122. The example HMS monitor 124 is an external entity outside of the context of the HMS 122 that detects and remediates failures in the HMS 122. That is, the HMS monitor 124 is a process that runs outside the HMS daemon to monitor the daemon. For example, the HMS monitor 124 can run alongside the HMS 122 in the same management switch as the HMS 122.

The example virtualization layer 108 includes an example virtual rack manager (VRM) 126. The example VRM 126 communicates with the HMS 122 to manage the physical hardware resources 112, 114. The example VRM 126 creates the example virtual server rack 104 out of underlying physical hardware resources 112, 114 that may span one or more physical racks (or smaller units such as a hyper-appliance or half rack) and handles physical management of those resources. The example VRM 126 uses the virtual server rack 104 as a basis of aggregation to create and provide operational views, handle fault domains, and scale to accommodate workload profiles. The example VRM 126 keeps track of available capacity in the virtual server rack 104, maintains a view of a logical pool of virtual resources throughout the SDDC life-cycle, and translates logical resource provisioning to allocation of physical hardware resources 112, 114. The example VRM 126 interfaces with components of a virtual system solutions provider, such as an example VMware vSphere® virtualization infrastructure components suite 128, an example VMware vCenter® virtual infrastructure server 130, an example ESXi™ hypervisor component 132, an example VMware NSX® network virtualization platform 134 (e.g., a network virtualization component or a network virtualizer), an example VMware NSX® network virtualization manager 136, and an example VMware vSAN™ network data storage virtualization component 138 (e.g., a network data storage virtualizer). In the illustrated example, the VRM 126 communicates with these components to manage and present the logical view of underlying resources such as hosts and clusters. The example VRM 126 also uses the logical view for orchestration and provisioning of workloads.

The VMware vSphere® virtualization infrastructure components suite 128 of the illustrated example is a collection of components to setup and manage a virtual infrastructure of servers, networks, and other resources. Example components of the VMware vSphere® virtualization infrastructure components suite 128 include the example VMware vCenter® virtual infrastructure server 130 and the example ESXi™ hypervisor component 132.

The example VMware vCenter® virtual infrastructure server 130 provides centralized management of a virtualization infrastructure (e.g., a VMware vSphere® virtualization infrastructure). For example, the VMware vCenter® virtual infrastructure server 130 provides centralized management of virtualized hosts and virtual machines from a single console to provide IT administrators with access to inspect and manage configurations of components of the virtual infrastructure.

The example ESXi™ hypervisor component 132 is a hypervisor that is installed and runs on servers in the example physical resources 112, 114 to enable the servers to be partitioned into multiple logical servers to create virtual machines.

The example VMware NSX® network virtualization platform 134 (e.g., a network virtualization component or a network virtualizer) virtualizes network resources such as physical hardware switches to provide software-based virtual networks. The example VMware NSX® network virtualization platform 134 enables treating physical network resources (e.g., switches) as a pool of transport capacity. In some examples, the VMware NSX® network virtualization platform 134 also provides network and security services to virtual machines with a policy driven approach.

The example VMware NSX® network virtualization manager 136 manages virtualized network resources such as physical hardware switches to provide software-based virtual networks. In the illustrated example, the VMware NSX® network virtualization manager 136 is a centralized management component of the VMware NSX® network virtualization platform 134 and runs as a virtual appliance on an ESXi host. In the illustrated example, a VMware NSX® network virtualization manager 136 manages a single vCenter server environment implemented using the VMware vCenter® virtual infrastructure server 130. In the illustrated example, the VMware NSX® network virtualization manager 136 is in communication with the VMware vCenter® virtual infrastructure server 130, the ESXi™ hypervisor component 132, and the VMware NSX® network virtualization platform 134.

The example VMware vSAN™ network data storage virtualization component 138 is software-defined storage for use in connection with virtualized environments implemented using the VMware vSphere® virtualization infrastructure components suite 128. The example VMware vSAN™ network data storage virtualization component clusters server-attached hard disk drives (HDDs) and solid state drives (SSDs) to create a shared datastore for use as virtual storage resources in virtual environments.

Although the example VMware vSphere® virtualization infrastructure components suite 128, the example VMware vCenter® virtual infrastructure server 130, the example ESXi™ hypervisor component 132, the example VMware NSX® network virtualization platform 134, the example VMware NSX® network virtualization manager 136, and the example VMware vSAN™ network data storage virtualization component 138 are shown in the illustrated example as implemented using products developed and sold by VMware, Inc., some or all of such components may alternatively be supplied by components with the same or similar features developed and sold by other virtualization component developers.

The virtualization layer 108 of the illustrated example, and its associated components are configured to run virtual machines. However, in other examples, the virtualization layer 108 may additionally or alternatively be configured to run containers. A virtual machine is a data computer node that operates with its own guest operating system on a host using resources of the host virtualized by virtualization software. A container is a data computer node that runs on top of a host operating system without the need for a hypervisor or separate operating system.

The virtual server rack 104 of the illustrated example enables abstracting the physical hardware resources 112, 114. In some examples, the virtual server rack 104 includes a set of physical units (e.g., one or more racks) with each unit including hardware 112, 114 such as server nodes (e.g., compute+storage+network links), network switches, and, optionally, separate storage units. From a user perspective, the example virtual server rack 104 is an aggregated pool of logic resources exposed as one or more vCenter ESXi™ clusters along with a logical storage pool and network connectivity. In examples disclosed herein, a cluster is a server group in a virtual environment. For example, a vCenter ESXi™ cluster is a group of physical servers in the physical hardware resources 112, 114 that run ESXi™ hypervisors (developed and sold by VMware, Inc.) to virtualize processor, memory, storage, and networking resources into logical resources to run multiple virtual machines that run operating systems and applications as if those operating systems and applications were running on physical hardware without an intermediate virtualization layer.

In the illustrated example, the example OAM component 110 is an extension of a VMware vCloud® Automation Center (VCAC) that relies on the VCAC functionality and also leverages utilities such as vRealize 140, Log Insight™, and Hyperic® to deliver a single point of SDDC operations and management. The example OAM component 110 is configured to provide different services such as heat-map service, capacity planner service, maintenance planner service, events and operational view service, and virtual rack application workloads manager service.

In the illustrated example, vRealize Automation® 140 is a cloud management platform that can be used to build and manage a multi-vendor cloud infrastructure. vRealize Automation® 140 provides a plurality of services that enable self-provisioning of virtual machines in private and public cloud environments, physical machines (install OEM images), applications, and IT services according to policies defined by administrators. For example, vRealize Automation® 140 may include a cloud assembly service to create and deploy machines, applications, and services to a cloud infrastructure, a code stream service to provide a continuous integration and delivery tool for software, and a broker service to provide a user interface to non-administrative users to develop and build templates for the cloud infrastructure when administrators to not need full access for building and developing. The example vRealize Automation® 140 may include a plurality of other services, not described herein, to facilitate building and managing the multi-vendor cloud infrastructure.

In the illustrated example, a heat map service of the OAM component 110 exposes component health for hardware mapped to virtualization and application layers (e.g., to indicate good, warning, and critical statuses). The example heat map service also weighs real-time sensor data against offered service level agreements (SLAs) and may trigger some logical operations to make adjustments to ensure continued SLA.

In the illustrated example, the capacity planner service of the OAM component 110 checks against available resources and looks for potential bottlenecks before deployment of an application workload. Example capacity planner service also integrates additional rack units in the collection/stack when capacity is expanded.

In the illustrated example, the maintenance planner service of the OAM component 110 dynamically triggers a set of logical operations to relocate virtual machines (VMs) before starting maintenance on a hardware component to increase the likelihood of substantially little or no downtime. The example maintenance planner service of the OAM component 110 creates a snapshot of the existing state before starting maintenance on an application. The example maintenance planner service of the OAM component 110 automates software upgrade/maintenance by creating a clone of the machines and proceeds to upgrade software on clones, pause running machines, and attaching clones to a network. The example maintenance planner service of the OAM component 110 also performs rollbacks if upgrades are not successful.

In the illustrated example, an events and operational views service of the OAM component 110 provides a single dashboard for logs by feeding to Log Insight. The example events and operational views service of the OAM component 110 also correlates events from the heat map service against logs (e.g., a server starts to overheat, connections start to drop, lots of HTTP/503 from App servers). The example events and operational views service of the OAM component 110 also creates a business operations view (e.g., a top down view from Application Workloads=>Logical Resource View=>Physical Resource View). The example events and operational views service of the OAM component 110 also provides a logical operations view (e.g., a bottom up view from Physical resource view=>vCenter ESXi Cluster View=>VM's view).

In the illustrated example, the virtual rack application workloads manager service of the OAM component 110 uses vCAC and vCAC enterprise services to deploy applications to vSphere hosts. The example virtual rack application workloads manager service of the OAM component 110 uses data from the heat map service, the capacity planner service, the maintenance planner service, and the events and operational views service to build intelligence to pick the best mix of applications on a host (e.g., not put all high CPU intensive apps on one host). The example virtual rack application workloads manager service of the OAM component 110 optimizes applications and virtual storage area network (vSAN) arrays to have high data resiliency and best possible performance at same time.

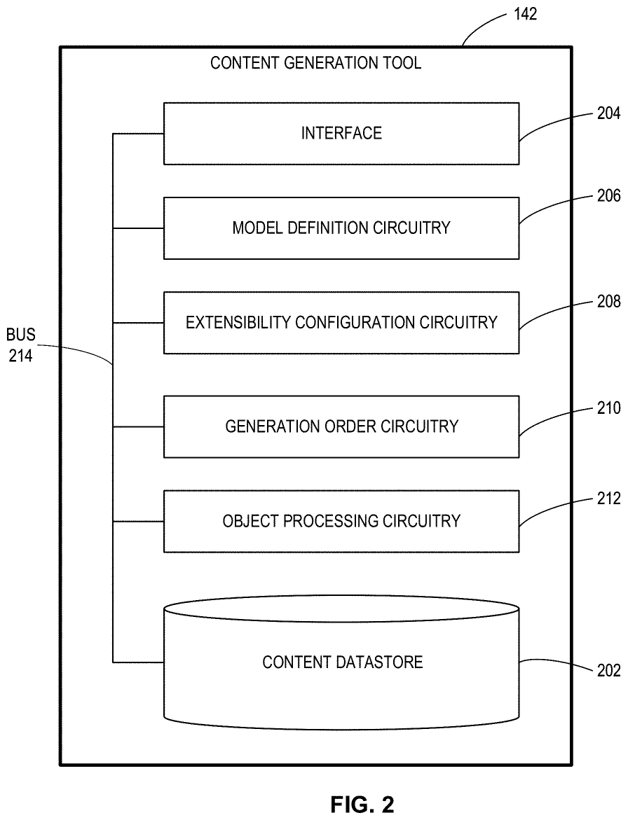

In the illustrated example of FIG. 1, the architecture 100 includes an example content generation tool 142. The content generation tool 142 is in communication with the vRealize Automation® component 140 via an example vRealize API 144. The example content generation tool 142 is a content generation system that facilitates processing of raw content into content that can be used by the vRealize Automation® component 140. For example, the content generation tool 142 is implemented by an application, processing circuitry, etc., that enables a developer to write, create, design, etc., programming content for the vRealize Automation® component 140 without having to edit and/or revise the raw content when uploading and/or deploying to the vRealize Automation® component 140. The example content generation tool 142 is described in further detail below in connection with FIG. 2.

Although the example VCAC, the example vRealize Automation® 140 utility, the example Log Insight™, the example Hyperic® are shown in the illustrated example as implemented using products developed and sold by VMware, Inc., some or all of such components may alternatively be supplied by components with the same or similar features developed and sold by other virtualization component developers. For example, the utilities leveraged by the cloud automation center may be any type of cloud computing platform and/or cloud management platform that delivers and/or provides management of the virtual and physical components of the architecture 100.

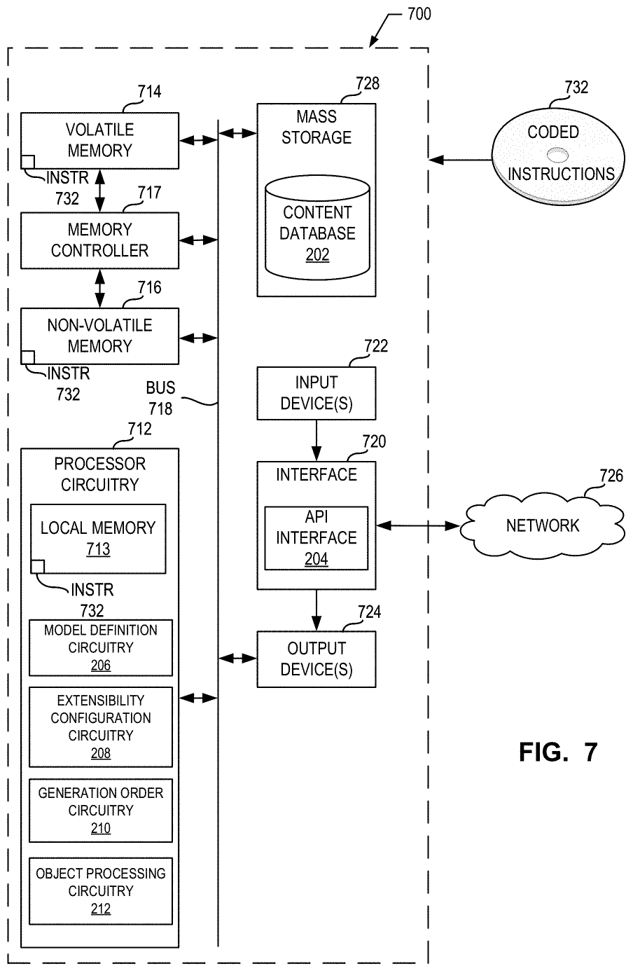

FIG. 2 is a block diagram of the example content generation tool 142 of FIG. 1 to process content that is to be implemented at a target system (e.g., a cloud computing platform such as the vRealize Automation® component 140 of FIG. 1). As used herein, a term “target system” refers to a cloud computing platform. The example content generation tool 142 includes an example content datastore 202, an example interface 204, example model definition circuitry 206, example extensibility configuration circuitry 208, example generation order circuitry 210, and example object processing circuitry 212. The example content datastore 202, the example interface 204, the example model definition circuitry 206, the example extensibility configuration circuitry 208, the example generation order circuitry 210, and the example object processing circuitry 212 are in communication with each other via a bus 214. In some examples, the bus 214 is implemented by bus 718 of the processor platform 700 of FIG. 7.

In FIG. 2, the content datastore 202 stores a plurality of content data (e.g., model definitions) and policies for generating content. For example, the content datastore 202 includes (e.g., stores) cloud template model definitions, cloud account model definitions, action model definitions, subscription model definitions, flavor mapping model definitions, image mapping model definitions, new and/or previous content projects, blueprints, etc. As used herein, a model definition is a representation of an entity and/or an object in the target system (e.g., the vRealize Automation® component 140 of FIG. 1). For example, a model definition named “Cloud Template” is a representation of an undefined cloud template in the target system. The example content datastore 202 includes a plurality of model definitions for a plurality of known entities in the target system.

In some examples, the content datastore 202 includes policies corresponding to the model definitions. The policies include actions to take in response to invocations of particular model definitions. For example, the policies identify various scenarios and include actions to take when one or more of the various scenarios occur. For example, a policy scenario and action may include when a first model definition is invoked, invoke a second model definition and a third model definition.

In some examples, the content datastore 202 includes a list of tightly coupled model definitions. As used herein, tightly coupled model definitions are model definitions that are related to each other. For example, during content creation, when a developer creates a model object X (which is an instance of a model definition x), the developer may also create model object Y (which is an instance of model definition y) because object X and object Y are utilized to create a specific content. Therefore, object X and object Y are related to each other and, thus, are tightly coupled. The example content datastore 202 includes information corresponding to such relationships between model definitions and the information can be utilized during content creation to facilitate extensibility and to reduce the time it takes to create the content. For example, conventionally, a developer is required to separately create and define the model object X, create and define the model object Y, and then link model object X to model object Y. However, the content generation tool 142 provides model definitions with extensibility to a developer environment that automatically facilitates that linkage between tightly coupled model definitions and eliminates the step the developer to create separate model objects and/or eliminates a step the target system takes to link objects.

The example content datastore 202 of this example may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The example content datastore 202 may additionally or alternatively be implemented by one or more double data rate (DDR) memories, such as DDR, DDR2, DDR3, DDR4, mobile DDR (mDDR), etc. The example content datastore 202 may additionally or alternatively be implemented by one or more mass storage devices such as hard disk drive(s), compact disk (CD) drive(s), digital versatile disk (DVD) drive(s), solid-state disk drive(s), etc. While in the illustrated example the content datastore 202 is illustrated as a single datastore, the content datastore 202 may be implemented by any number and/or type(s) of datastores. Furthermore, the data stored in the content datastore 202 may be in any data format such as, for example, binary data, comma delimited data, tab delimited data, structured query language (SQL) structures, etc.

In FIG. 2, the example interface 204 is to facilitate communications between the content generation tool 142 and the target system API (e.g., the vRealize API 144) and between the content generation tool 142 and the developer environment. The interface 204 interfaces with the target system API (e.g., vRealize API 144) which may include routines, protocols, function calls, and other components defined for use by external programs, routines, or components to communicate with the target system (e.g., the vRealize component 140). In some examples, the interface 204 interfaces with the developer environment to provide rules and/or instructions for the developer environment to implement. For example, the interface 204 can communicate the policies, stored in the content datastore 202, to the developer environment when the developer environment invokes and/or depends on the content generation tool 142. In some examples, the interface 204 may be implemented by a network interface card (NIC). In some examples, the interface 204 may be an API.

In FIG. 2, the example model definition circuitry 206 is to create model definitions for a developer environment to utilize. As described above, a model definition is a representation of the target system object. A model definition may include a predefined number of required fields. The fields correspond to one or more fields of target system objects. A model definition may include a predefined number of optional fields. For example, a model definition named “Cloud Template” is a representation of “Cloud Template” in the target system. In that model definition, the model definition circuitry 206 has defined that “Cloud Template” must have a name field and may optionally have an extensibility field. In some examples, the model definition circuitry 206 provides mapping in the model definitions. For example, the model definition circuitry 206 provides a mapping table, a mapping object, etc., in the model definition that maps fields to target system fields. In some examples, the object processing circuitry 212 utilize the mapping table, mapping objects, etc., to process the model objects. The example model definition circuitry 206 may be configured by a system administrator. For example, a system administrator may configure the model definition circuitry 206 to define and/or generate the model definitions for storing at the content datastore 202. In some examples, the model definition circuitry 206 implements a trained machine learning model that learns how to create model definitions. For example, a trained machine learning model may be invoked and/or utilized when a developer environment includes an object that has not yet been created by the content generation tool 142. In such an example, the model definition circuitry 206 may utilize machine learning to build and/or create a model definition based on the unknown object. In some examples, model definitions are in a specific format that can be converted to the format of target system objects. As such, the machine learning model may be trained to create model definitions in the specific format.

In FIG. 2, the example extensibility configuration circuitry 208 is to identify extensible objects. In some examples, the extensibility configuration circuitry 208 identifies extensible objects based on previously defined and/or previously determined relationships between target system objects. For example, the target system may include information corresponding to which target system objects are related to each other and/or used in connection with each other. In some examples, the extensibility configuration circuitry 208 is configured with such information corresponding to the relationships between objects. In some examples, the extensibility configuration circuitry 208 is to facilitate extending capabilities of the content by suggesting adding additional components to the content, such as tightly coupled model objects, to form the content. In some examples, the extensibility configuration circuitry 208 configures policies that identify tightly coupled model objects (e.g., undefined model objects) and guide a generation of model objects at the developer environment. In such examples, the extensibility configuration circuitry 208 identifies a scenario that could occur during content creation and creates a policy and/or rule for the scenario. For example, the extensibility configuration circuitry 208 determines that when a developer environment creates object X, they also create an object Y that is linked to object X. In this example, the extensibility configuration circuitry 208 creates a policy indicative that when object X is created, request object Y to also be created and/or informs the model definition circuitry 206 to create a model definition for object X that includes object Y. In some examples, the extensibility configuration circuitry 208 updates the content datastore 202 with the policies. In such an example, when a developer environment invokes and/or depends on the content generation tool 142, the content datastore 202 provides the developer environment with policies and/or rules to enforce during content creation. In some examples, a system administrator provides the policies to the extensibility configuration circuitry 208 to generate into rules, instructions, etc. In some examples, the extensibility configuration circuitry 208 generates policy-based instructions that cause the developer environment to add extensibility to relative model definitions.

In FIG. 2, the example generation order circuitry 210 is to order files and contents of the file in an order for processing. For example, the generation order circuitry 210 is to identify a sequence in which content files are to be processed. In some examples, the sequence in which the content files are to be processed is defined by dependencies. For example, one file may depend on a different file, one model object may depend on execution of a different model object, etc. Therefore, the example generation order circuitry 210 is to identify the generation order of the content files. In some examples, the generation order circuitry 210 is provided with the generation order of the content. For example, the content files obtained from a developer environment may be labelled (e.g., named, identified, etc.) in the order of which they are to be processed. In some examples, the content files are labelled because the policies, provided by the content generation tool 142, instruct the developer environment to request that the files be named in a particular order, corresponding to the desired generation order. For example, each time the content generation tool 142 is invoked and/or depended on, the developer environment is provided with policies that instruct the developer to label content files in order of their dependency. Once deployed, the generation order circuitry 210 can identify which content files to process first, second, third, etc.

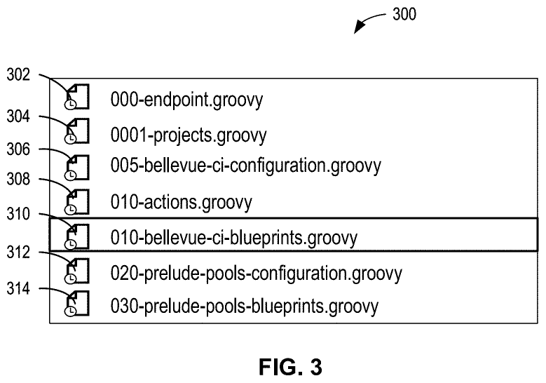

For example, a view of an example digital folder 300 including labelled content files 302, 304, 306, 308, 310, 312, and 314 is illustrated in FIG. 3. The content files 302, 304, 306, 308, 310, 312, and 314 are content including one or more model objects that are to be processed by the content generation tool 142 and executed by the target system. The example labelled content files 302, 304, 306, 308, 310, 312, and 314 include a prefix with a three digit numerical value, a name, and a type. For example, a first labelled content file 302 includes numerical value “000,” name “endpoint,” and type “.groovy.” The name of the content file describes the content and the type describes the type of file created in the developer environment. The three digit numerical value describes a point and/or an index in which the file is to be processed. For example, files having lower numbers are processed first and files with the same number are processed in parallel. In some examples, the numerical value describes a dependency of the file. For example, a second labelled content file 304 includes numerical value “001” and name “projects.” The “project” file depends on the “endpoint” file, as indicated by the numerical value. For example, the “endpoint” file is to be processed before the “project” file can be processed, because the “project” file may utilize the “endpoint” file.

In the example of FIG. 3, the first content file 302 is to be processed first. The second content file 304 is to be processed after the first content file 302 and depends on the first content file 302. A third content file 306, having a numerical label of “005,” is to be processed after the second content file 304 and depends on the second content file 304. A fourth content file 308 and a fifth content file 310, having a numerical label of “010,” are to be processed in parallel and after the third content file 306. The fourth content file 308 and the fifth content file 310 can be processed in parallel because they both depend on the third content file 306 and not on each other. A sixth content file 312, having a numerical label of “020,” is to be processed after the fourth and fifth content files 308, 310 and depend on the fourth and fifth content files 308, 310. A seventh content file 314, having a numerical label of “030,” is to be processed after the sixth content file 312 and depends on the sixth content file 312.

In some examples, the developer of the content files 302, 304, 306, 308, 310, 312, and 314 is instructed to label the content files 302, 304, 306, 308, 310, 312, and 314 in this manner in order for the generation order circuitry 210, and/or more generally, the content generation tool 142, to process the files correctly. In some examples, if the content files 302, 304, 306, 308, 310, 312, and 314 are incorrectly labelled, an error may occur during processing. For example, the object processing circuitry 212 may load and/or attempt to load the third content file 306 having model objects defined by the second content file 304 but not yet processed, which results in a processing error.

In FIG. 2, the example generation order circuitry 210 is to process entities (e.g., model objects) inside the content files sequentially. For example, the model objects are processed in a logical order defined by the developer.

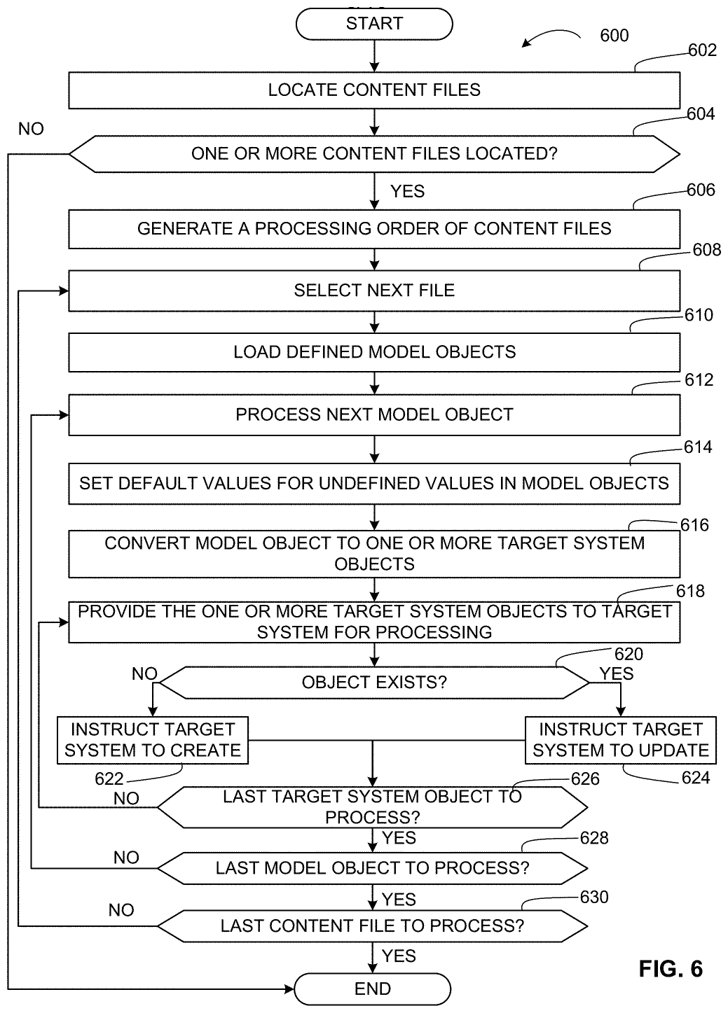

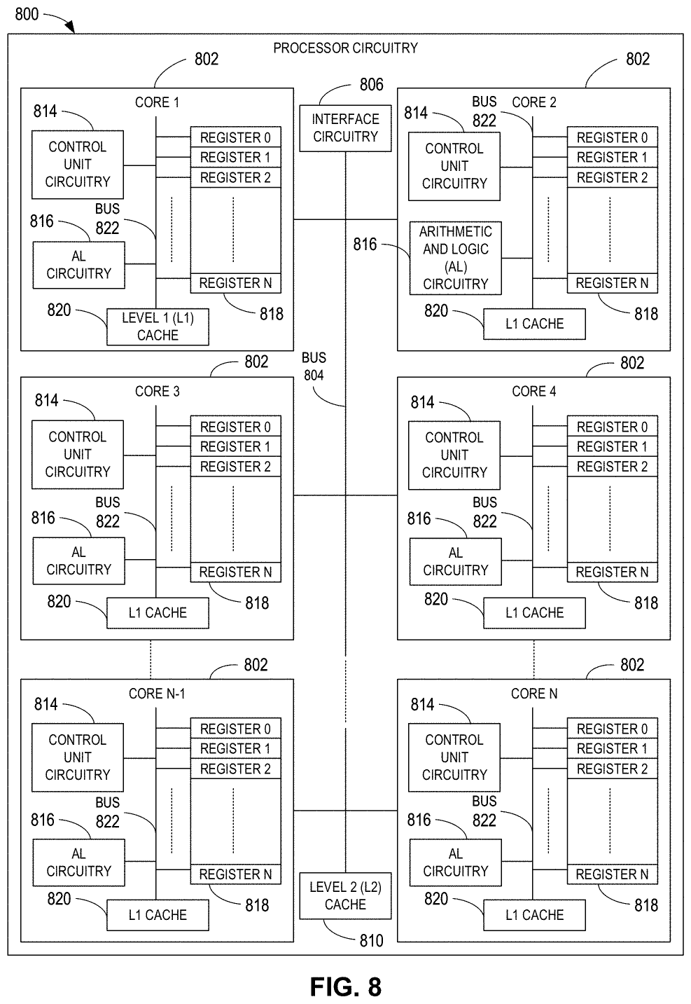

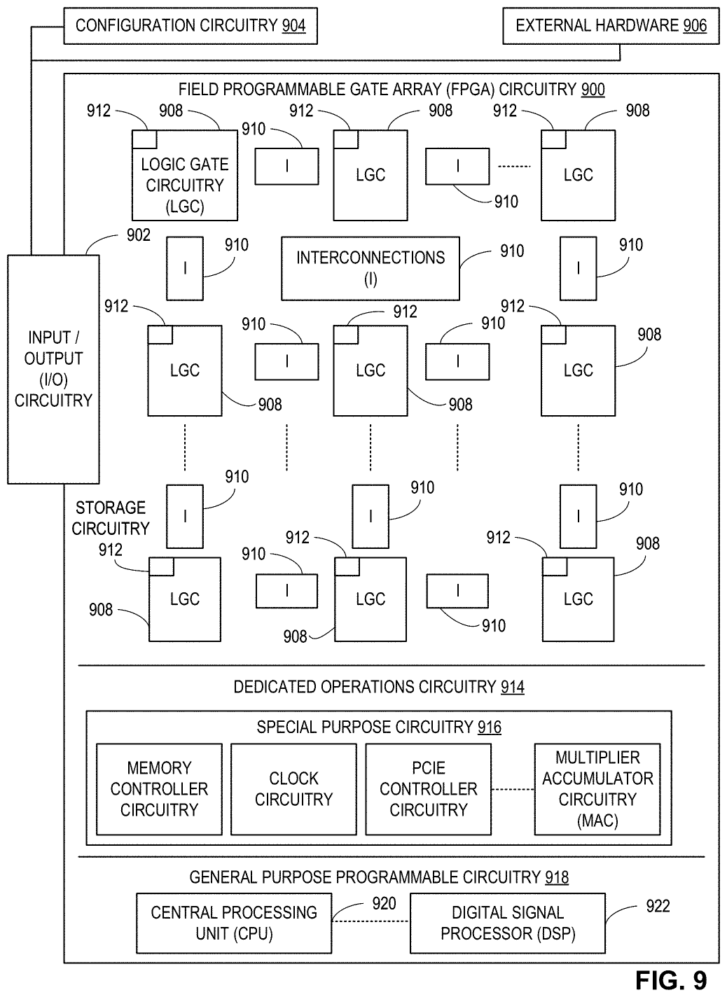

In some examples, the generation order circuitry 210 includes means for generating a processing order of content files. For example, the means for generating a processing order may be implemented by generation order circuitry 210. In some examples, the generation order circuitry 210 may be implemented by machine executable instructions such as that implemented by at least blocks 602, 604, 606, and/or 630 of FIG. 6 executed by processor circuitry, which may be implemented by the example processor circuitry 712 of FIG. 7, the example processor circuitry 800 of FIG. 8, and/or the example Field Programmable Gate Array (FPGA) circuitry 900 of FIG. 9. In other examples, the generation order circuitry 210 is implemented by other hardware logic circuitry, hardware implemented state machines, and/or any other combination of hardware, software, and/or firmware. For example, the generation order circuitry 210 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In FIG. 2, the object processing circuitry 212 processes the objects in the generation order defined and/or identified by the generation order circuitry 210. In some examples, the object processing circuitry 212 may act as a generic processor that follows an order of execution to process the content. In some examples, the object processing circuitry 212 sets default values for any undefined values in the model objects. For example, during processing, the object processing circuitry 212 calls functions having values and initializes and/or defines functions with default values when the function being called does not have a value. The example object processing circuitry 212 may obtain objects to process from the content datastore 202 and managed by the generation order circuitry 210. For example, the generation order circuitry 210 may act as a memory controller that provides contents of the content datastore 202 to the object processing circuitry 212 in a specific order for processing.

In some examples, the object processing circuitry 212 is to convert model objects to one or more target system objects during processing. For example, the object processing circuitry 212 is to convert the model objects, defined by/at the content generation tool 142, to objects that are readable by the target system. In some examples, the object processing circuitry 212 maps the data defining fields of the model objects to a fields of the target system objects. For example, the fields in the model definitions are mapped to fields of the target system objects, and the data that has been defined in the model definitions are inserted into their respective target system fields by the object processing circuitry 212. The example object processing circuitry 212 utilizes mapping tables and/or mapping objects from the model definitions to map data from fields of the model definition objects to fields of the target system objects. In this manner, the example object processing circuitry 212 facilitates a content development environment that is easy to use in connection with a target system. In some examples, the object processing circuitry 212 is circuitry that implements porting. As used herein, porting is referred to as adapting code from one environment to another environment (e.g., from the content generation tool 142 to the vRealize Automation® component 140). In some examples, the object processing circuitry 212 provides the converted objects to the target system via the interface 204.

In some examples, the object processing circuitry 212 includes means for processing objects. For example, the means for processing objects may be implemented by object processing circuitry 212. In some examples, the object processing circuitry 212 may be implemented by machine executable instructions such as that implemented by at least blocks 608, 610, 612, 614, 616, 618, 620, 622, 624, 626, and/or 628 of FIG. 6 executed by processor circuitry, which may be implemented by the example processor circuitry 712 of FIG. 7, the example processor circuitry 800 of FIG. 8, and/or the example Field Programmable Gate Array (FPGA) circuitry 900 of FIG. 9. In other examples, the object processing circuitry 212 is implemented by other hardware logic circuitry, hardware implemented state machines, and/or any other combination of hardware, software, and/or firmware. For example, the object processing circuitry 212 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

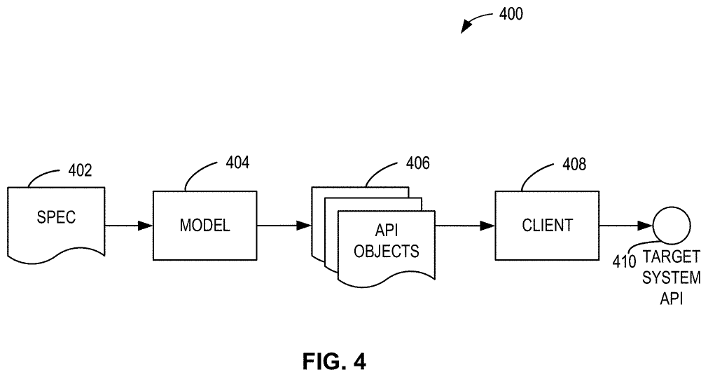

FIG. 4 is a block diagram of an example operation 400 of the content generation tool 142 to process content for a target system. In this example, the target system is the vRealize Automation® component 140 of FIG. 1. In some examples, the target system is any cloud computing platform. The example operation 400 includes an example specification 402, an example model 404, example API objects 406, an example client 408, and an example target system API 410.

In FIG. 4, the example specification 402 is text, description, etc., that a developer creates/develops to make content. In some examples, the specification 402 is raw, new text that is written by the developer. The specification 402 may be written based on model definitions and policies defined by the content generation tool 142 and enforced by whatever environment the developer uses to create the specification 402. For example, the specification 402 may be in a format that mimics and/or copies the format of model definitions created by the model definition circuitry 206.

In FIG. 4, the example model 404 is the content generation tool 142 that processes and converts the specification 402 into API object(s) 406. For example, the model 404 may be implemented by the generation order circuitry 210 and the object processing circuitry 212 that determines when to process the specification 402 and how to process the specification 402. The model 404 obtains logic for translating the specification 402 into API objects 406 that are executable by the target system.

In FIG. 4, the example API objects 406 are objects that can be executed by the target system. The example API objects 406 are representative of the specification 402, but in a language and/or form that is readable by the target system.

In FIG. 4, the client 408 is the content generation tool 142 that provides the API objects 406 to the target system via the target system. For example, the client 408 is implemented by the interface 204 of FIG. 2.

In the example operation 400, the model 404 obtains the specification 402 from a developer environment, such as an integrated development environment (IDE). The specification 402 includes content that is intended to run on the target system. The model 404 determines an order for which the specification 402 is to be generated. For example, the model 404 may place the specification 402 at a point in the path of processing based on other specifications being processed. The model 404 processes the specification 402 and generates API objects 406. For example, the model 404 translates the specification 402 into API objects 406 that can be executed by the target system (e.g., the vRealize Automation® component 140 of FIG. 1). The client 408 transmits the API objects 406 to the target system via the target system API 410.

While an example manner of implementing the content generation tool 142 of FIG. 1 is illustrated in FIG. 2, one or more of the elements, processes, and/or devices illustrated in FIG. 2 may be combined, divided, re-arranged, omitted, eliminated, and/or implemented in any other way. Further, the example content datastore 202, the example interface 204, the example model definition circuitry 206, the example extensibility configuration circuitry 208, the example generation order circuitry 210, the example object processing circuitry 212, and/or, more generally, the example content generation tool 142 of FIG. 1, may be implemented by hardware, software, firmware, and/or any combination of hardware, software, and/or firmware. Thus, for example, any of the example content datastore 202, the example interface 204, the example model definition circuitry 206, the example extensibility configuration circuitry 208, the example generation order circuitry 210, the example object processing circuitry 212, and/or, more generally, the example content generation tool 142, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example content datastore 202, the example interface 204, the example model definition circuitry 206, the example extensibility configuration circuitry 208, the example generation order circuitry 210, and/or the example object processing circuitry 212 is/are hereby expressly defined to include a non-transitory computer readable storage device or storage disk such as a memory, a digital versatile disk (DVD), a compact disk (CD), a Blu-ray disk, etc., including the software and/or firmware. Further still, the example content generation tool 142 of FIG. 1 may include one or more elements, processes, and/or devices in addition to, or instead of, those illustrated in FIG. 2, and/or may include more than one of any or all of the illustrated elements, processes and devices.

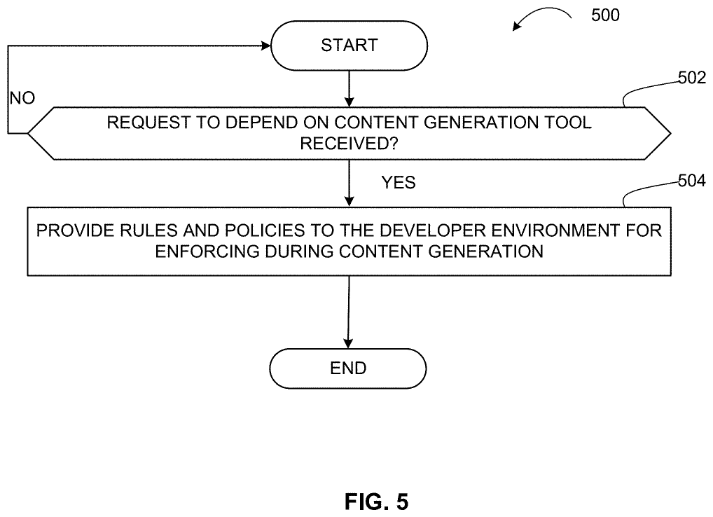

Flowcharts representative of example hardware logic circuitry, machine readable instructions, hardware implemented state machines, and/or any combination thereof for implementing the content generation tool 142 of FIG. 2 are shown in FIGS. 5-6. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 5-6, many other methods of implementing the example content generation tool 142 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to facilitate developing and/or creating content for a target system. The machine readable instructions and/or operations 500 of FIG. 5 begin at block 502, at which the content generation tool 142 determines whether a request to depend on the content generation tool 142 has been received. For example, the interface 204 (FIG. 2) may obtain a message from a developer environment (e.g., an IDE) that content is to be written for a target system (e.g., the vRealize component 140 of FIG. 1).

The example content generation tool 142 provides rules and policies to the developer environment for enforcing during content generation (block 504). For example, the interface 204 provides model definitions and policies corresponding to relationships between model definitions. In some examples, the content generation tool 142 causes the developer environment to enforce the rules and policies of the content generation tool 142. For example, the content generation tool 142 provides instructions with the policies and rules that cause the developer environment to enforce the policies and rules during content generation. For example, a policy may include that when object X is called, define a name field and an extensibility field. In an example where the developer environment calls object X and writes (e.g., defines) a name field, an extensibility field, and an address field, the instructions, provided by the content generation tool 142, cause the developer environment to generate an error message, generate an error notification, change a color of the text, etc., that is/are indicative that an address field is not included in the model definition for object X. As such, a developer can revise the object X to conform to the policies of the content generation tool 142.

In some examples, the model definition circuitry 206 generates instructions that cause a developer environment and/or any content generation service to conform to the policies of the content generation tool 142. The instructions ensure that when the content generation tool 142 is to transform the content into target system objects, it is possible to transform them without assistance from any type of source (e.g., such as the developer environment, a system administrator, etc.).

The example operations 500 of FIG. 5 may end when the example content generation tool 142 provides rules and policies to a requesting entity (e.g., the developer environment).

FIG. 6 is a flowchart representative of example machine readable instructions and/or example operations 600 that may be executed and/or instantiated by processor circuitry to process content for the target system. The machine readable instructions and/or operations 600 of FIG. 6 begin at block 602, at which the content generation tool 142 locates content files. For example, the generation order circuitry 210 queries the content datastore 202 for content files developed and validated and ready for deployment.

The example content generation tool 142 determines if one or more content files were located (block 604). For example, the generation order circuitry 210 determines if there was a hit in the content datastore 202 for content files that were validated and ready to be deployed. If the example content generation tool 142 determines that no content files were located (e.g., block 604 returns a value NO), the example operations 600 end.

If the example content generation tool 142 determines that at least one or more content files were located (e.g., block 604 returns a value YES), the example content generation tool 142 generates a processing order of content files (block 606). For example, the generation order circuitry 210 identifies an order of which the content files are to be processed. In some examples, the generation order circuitry 210 analyzes labels of the files to determine the order at which the files are to be processed. For example, the content file having a lowest numerical value in the label is processed first, the content file having a second lowest numerical value in the label is processed second, etc. In some examples the generation order circuitry 210 analyzes dependencies of the files to determine the order at which they are to be processed. For example, the generation order circuitry 210 analyzes and/or scans the content files for dependencies to determine which content files to process first, second, third, in parallel, etc.

The example content generation tool 142 selects a next file (block 608). For example, the generation order circuitry 210 places a pointer on the file that is to be processed based on the order determined at block 606. In some examples, the generation order circuitry 210 notifies and/or provides the next file to the object processing circuitry 212 (FIG. 2) for processing.

The example content generation tool 142 loads defined model objects (block 610). For example, the object processing circuitry 212 queues the model objects in the selected content file for processing. In some examples, the object processing circuitry 212 loads the model objects in a cache to queue the model objects in the selected content file.

The example content generation tool 142 processes next model object (block 612). For example, the object processing circuitry 212 processes the loaded model objects sequentially and, thus, selects a first (e.g., next) model object to process based on the queue of loaded model objects.

The example content generation tool 142 sets default values for undefined values in the model objects (block 614). For example, the object processing circuitry 212 determines, during processing, whether any fields in the objects are undefined. In some examples, a developer may become lazy and/or forgetful during content creation. In such examples, since the developer used the model definitions generated and provided by the content generation tool 142, the object processing circuitry 212 can fill in the blanks for them. In some examples, when default values do not exist (e.g., when the object processing circuitry 212 processes an object with an unknown and undefined field), the object processing circuitry 212 may define the value as null, void, etc.

The example content generation tool 142 converts the model object to one or more target system objects (block 616). For example, the object processing circuitry 212 utilizes a mapping table, a mapping object, etc., to map data, defining fields in the model object, to one or more fields of target system objects. In some examples, the mapping table and/or mapping object includes logic indicative of converting one model object into two or more model objects based on the required and/or optional fields in the model object. For example, an “endpoint” model object having a defined name field, a defined username field, a defined uniform resource locator (URL) field and a defined password field is to be split into two target system objects: 1) an endpoint target system object for the name field, the username field, and the URL field and 2) a variable target system object for the password field. The example object processing circuitry 212 utilizes the mapping table and/or mapping object to determine the conversion

The example content generation tool 142 provides the one or more target system objects to the target system for processing (block 618). For example, the object processing circuitry 212 and/or the interface 204 sends the target system object(s) to the target system.

The example content generation tool 142 determines if the object exists (block 620). For example, the interface 204 waits for an acknowledgement from the target system corresponding to whether the object is an object utilized, defined, known, etc., at the target system.

In some examples, if the content generation tool 142 determines that the object does not exist (e.g., block 620 returns a value NO), the content generation tool 142 instructs the target system to create (block 622). For example, the interface 204 provides instructions to the target system to create an instance of the new object in the target system database with the one or more target system objects converted at block 616.

In some examples, if the content generation tool 142 determines that the object does exist (e.g., block 620 returns a value YES), the content generation tool 142 instructs the target system to update (block 624). For example, the interface 204 provides instructions to the target system to update the object in the target system database corresponding to the one or more target system objects converted at block 616. In some examples, updating the target system object includes updating the values and/or data in the target system object, updating the name(s) of the target system object, etc.

The example content generation tool 142 determines whether the target system object is the last target system object to process (block 626). For example, the object processing circuitry 212 checks a queue for another target system object to send to the target system.

In some examples, if the content generation tool 142 determines there is another target system object to process (e.g., block 626 returns a value NO), the content generation tool 142 returns to block 618. For example, the object processing circuitry 212 sends the next target system object(s) in the queue to the target system.

In some examples, if the content generation tool 142 determines there is not another target system object to process (e.g., block 626 returns a value YES), the content generation tool 142 determines if the model object is the last model object to process (block 628). For example, the object processing circuitry 212 checks the queue to determine if there is another model object in the selected content file to process (e.g., to convert to a target system object).

In some examples, the if the content generation tool 142 determines there is another model object to process (e.g., block 628 returns a value NO), the content generation tool 142 returns to block 612. For example, the object processing circuitry 212 selects the next model object in the queue and/or sequence to process (e.g., to convert to a target system object).

In some examples, if the content generation tool 142 determines there is not another model object to process (e.g., block 628 returns a value YES), the content generation tool 142 determines if the content file is the last content file to process (block 630). For example, the generation order circuitry 210 checks the queue and/or processing order to identify if another content file is to be loaded and processed.

In some examples, if the content generation tool 142 determines there is another content file to process (e.g., block 630 returns a value NO), the content generation tool 142 returns to block 608. For example, the generation order circuitry 210 identifies the next file in the processing order to process.

In some examples, if the content generation tool 142 determines there is not another content file to process (e.g., block 630 returns a value YES), the example operations 600 end. For example, the content intended to be deployed and executed by the target system has been processed and converted into target system content that can be utilized by the target system. The example operations 600 may be repeated when new content is loaded and/or obtained by the content generation tool 142.

FIG. 7 is a block diagram of an example processor platform 700 structured to execute and/or instantiate the machine readable instructions and/or operations of FIGS. 5-6 to implement the content generation tool 142 of FIGS. 1 and 2. The processor platform 700 can be, for example, a server, a personal computer, a workstation, a self-learning machine (e.g., a neural network), a mobile device (e.g., a cell phone, a smart phone, a tablet such as an iPad™), an Internet appliance, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example model definition circuitry 206, the example extensibility configuration circuitry 208, the example generation order circuitry 210, and the example object processing circuitry 212.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In this example, the interface circuitry 720 implements the example interface 204.

In the illustrated example, one or more input devices 722 are connected to the interface circuitry 720. The input device(s) 722 permit(s) a user to enter data and/or commands into the processor circuitry 712. The input device(s) 422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output devices 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices, and DVD drives. In this example, the mass storage devices 728 implement the example content datastore 202.

The machine executable instructions 732, which may be implemented by the machine readable instructions of FIGS. 5-6, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a microprocessor 800. For example, the microprocessor 800 may implement multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIGS. 5-6.

The cores 802 may communicate by an example bus 804. In some examples, the bus 804 may implement a communication bus to effectuate communication associated with one(s) of the cores 802. For example, the bus 804 may implement at least one of an Inter-Integrated Circuit (I2C) bus, a Serial Peripheral Interface (SPI) bus, a PCI bus, or a PCIe bus. Additionally or alternatively, the bus 804 may implement any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2_ cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the L1 cache 820, and an example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The bus 804 may implement at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 9 is a block diagram of another example implementation of the processor circuitry 712 of FIG. 7. In this example, the processor circuitry 712 is implemented by FPGA circuitry 900. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 5-6 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowcharts of FIGS. 5-6. In particular, the FPGA 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowcharts of FIGS. 5-6. As such, the FPGA circuitry 900 may be structured to effectively instantiate some or all of the machine readable instructions of the flowcharts of FIGS. 5-6 as dedicated logic circuits to perform the operations corresponding to those software instructions in a dedicated manner analogous to an ASIC. Therefore, the FPGA circuitry 900 may perform the operations corresponding to the some or all of the machine readable instructions of FIGS. 5-6 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware (e.g., external hardware circuitry) 906. For example, the configuration circuitry 904 may implement interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may implement the microprocessor 800 of FIG. 9. The FPGA circuitry 900 also includes an array of example logic gate circuitry 908, a plurality of example configurable interconnections 910, and example storage circuitry 912. The logic gate circuitry 908 and interconnections 910 are configurable to instantiate one or more operations that may correspond to at least some of the machine readable instructions of FIGS. 5-6 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 6 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowcharts of FIGS. 5-6 may be executed by one or more of the cores 802 of FIG. 8 and a second portion of the machine readable instructions represented by the flowcharts of FIGS. 5-6 may be executed by the FPGA circuitry 900 of FIG. 6.

In some examples, the processor circuitry 712 of FIG. 7 may be in one or more packages. For example, the processor circuitry 800 of FIG. 8 and/or the FPGA circuitry 900 of FIG. 5 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

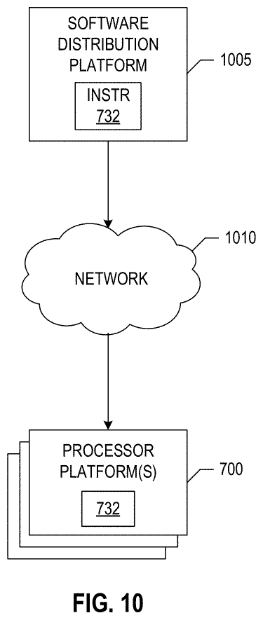

A block diagram illustrating an example software distribution platform 1005 to distribute software such as the example machine readable instructions 732 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions 500 and 600 of FIGS. 5-6, as described above. The one or more servers of the example software distribution platform 1005 are in communication with a network 1010, which may correspond to any one or more of the Internet and/or any of the example networks 120 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions 500 and 600 of FIGS. 5-6, may be downloaded to the example processor platform 700, which is to execute the machine readable instructions 732 to implement the content generation tool 142. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices.

From the foregoing, it will be appreciated that example systems, methods, apparatus, and articles of manufacture have been disclosed that facilitate content generation for cloud computing systems, such as vRealize Automation®. The content generation tool described herein improves the content created to run on the cloud computing systems and reduces the time it takes to develop the content. The content generation tool described herein provides reusable and extensible code that enables a developer to quickly create projects, applications, etc., in cloud computing systems. The disclosed systems, methods, apparatus, and articles of manufacture improve the efficiency of using a computing device by reducing an amount of computational power utilized during content generation and content integration because the content generation tool provides pre-configured content that merely needs to be defined by data and/or values instead of being written completely new and that can be integrated into a target system in an efficient manner. The disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to facilitate content generation for cloud computing platforms are disclosed herein. Further examples and combinations thereof include the following:

Example 1 includes an apparatus comprising model definition circuitry to generate model definitions representative of one or more undefined target system objects in a target system, and generate instructions that cause a developer environment to provide the model definitions during a generation of content files, generation order circuitry to generate a processing order of the content files, the content files having one or more defined model objects, and object processing circuitry to convert the one or more defined model objects to defined target system objects for deployment and execution at the target system.

Example 2 includes the apparatus of example 1, further including extensibility configuration circuitry to identify extensible model objects based on previously defined relationships between previous target system objects.

Example 3 includes the apparatus of example 1, further including extensibility configuration circuitry to add extensible undefined model objects to the model definitions, the extensible undefined model objects to extend a capability of the model definitions.

Example 4 includes the apparatus of example 1, further including extensibility configuration circuitry to configure policies corresponding to tightly coupled undefined model objects, the policies to guide a generation of model objects at the developer environment.

Example 5 includes the apparatus of example 4, wherein the extensibility configuration circuitry is to generate policy-based instructions based on the policies corresponding to tightly coupled model objects, the policy-based instructions to cause the developer environment to add extensibility to model definitions.

Example 6 includes the apparatus of example 1, wherein the generation order circuitry is to determine the processing order of the content files based on respective labels of the content files, wherein a first respective label having a lowest numerical value in the first respective label is to be processed first and a second respective label having a second lowest numerical value in the second respective label is to be processed second.

Example 7 includes the apparatus of example 1, wherein the object processing circuitry is to deploy the defined target system objects at the target system to determine if the defined target system objects are included in the target system, and when the defined target system objects do not exist at the target system, create new instances of the defined target system objects at the target system.

Example 8 includes a non-transitory computer readable storage medium comprising instructions that, when executed, cause one or more processors to at least generate model definitions representative of one or more undefined target system objects in a target system, generate instructions that cause a developer environment to provide the model definitions during a generation of content files, generate a processing order of the content files, the content files having one or more defined model objects, and convert the one or more defined model objects to defined target system objects for deployment and execution at the target system.

Example 9 includes the non-transitory computer readable storage medium of example 8, wherein the instructions, when executed, cause the one or more processors to identify extensible model objects based on previously defined relationships between previous target system objects.

Example 10 includes the non-transitory computer readable storage medium of example 8, wherein the instructions, when executed, cause the one or more processors to add extensible undefined model objects to the model definitions, the extensible undefined model objects to extend a capability of the model definitions.

Example 11 includes the non-transitory computer readable storage medium of example 8, wherein the instructions, when executed, cause the one or more processors to configure policies corresponding to tightly coupled undefined model objects, the policies to guide a generation of model objects at the developer environment.

Example 12 includes the non-transitory computer readable storage medium of example 11, wherein the instructions, when executed, cause the one or more processors to generate policy-based instructions based on the policies corresponding to tightly coupled model objects, the policy-based instructions to cause the developer environment to add extensibility to model definitions.

Example 13 includes the non-transitory computer readable storage medium of example 8, wherein the instructions, when executed, cause the one or more processors to determine the processing order of the content files based on respective labels of the content files, wherein a first respective label having a lowest numerical value in the first respective label is to be processed first and a second respective label having a second lowest numerical value in the second respective label is to be processed second.

Example 14 includes the non-transitory computer readable storage medium of example 8, wherein the instructions, when executed, cause the one or more processors to deploy the defined target system objects at the target system to determine if the defined target system objects are included in the target system, and when the defined target system objects do not exist at the target system, create new instances of the defined target system objects at the target system.

Example 15 includes an apparatus comprising at least one memory, computer readable instructions, and processor circuitry to execute the instructions to at least create model definitions representative of one or more undefined target system objects in a target system, generate instructions that cause a developer environment to provide the model definitions during a generation of content files, generate a processing order of the content files, the content files having one or more defined model objects, and convert the one or more defined model objects to defined target system objects for deployment and execution at the target system.

Example 16 includes the apparatus of example 15, wherein the processor circuitry is to identify extensible model objects based on previously defined relationships between previous target system objects.

Example 17 includes the apparatus of example 15, wherein the processor circuitry is to add extensible undefined model objects to the model definitions, the extensible undefined model objects to extend a capability of the model definitions.

Example 18 includes the apparatus of example 15, wherein the processor circuitry is to configure policies corresponding to tightly coupled undefined model objects, the policies to guide a generation of model objects at the developer environment and generate policy-based instructions based on the policies corresponding to tightly coupled model objects, the policy-based instructions to cause the developer environment to add extensibility to model definitions.

Example 19 includes the apparatus of example 1, wherein the processor circuitry is to determine the processing order of the content files based on respective labels of the content files, wherein a first respective label having a lowest numerical value in the first respective label is to be processed first and a second respective label having a second lowest numerical value in the second respective label is to be processed second.

Example 20 includes the apparatus of example 15, wherein the processor circuitry is to deploy the defined target system objects at the target system to determine if the defined target system objects are included in the target system, and when the defined target system objects do not exist at the target system, create new instances of the defined target system objects at the target system.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
model definition circuitry to:
generate model definitions representative of one or more undefined target system objects in a target system; and
generate instructions that cause a developer environment to provide the model definitions during a generation of content files;
generation order circuitry to generate a processing order of the content files, the content files having one or more defined model objects; and
object processing circuitry to convert the one or more defined model objects to defined target system objects for deployment and execution at the target system.

2. The apparatus of claim 1, further including extensibility configuration circuitry to identify extensible model objects based on previously defined relationships between previous target system objects.

3. The apparatus of claim 1, further including extensibility configuration circuitry to add extensible undefined model objects to the model definitions, the extensible undefined model objects to extend a capability of the model definitions.

4. The apparatus of claim 1, further including extensibility configuration circuitry to configure policies corresponding to tightly coupled undefined model objects, the policies to guide a generation of model objects at the developer environment.

5. The apparatus of claim 4, wherein the extensibility configuration circuitry is to generate policy-based instructions based on the policies corresponding to tightly coupled model objects, the policy-based instructions to cause the developer environment to add extensibility to model definitions.

6. The apparatus of claim 1, wherein the generation order circuitry is to determine the processing order of the content files based on respective labels of the content files, wherein a first respective label having a lowest numerical value in the first respective label is to be processed first and a second respective label having a second lowest numerical value in the second respective label is to be processed second.

7. The apparatus of claim 1, wherein the object processing circuitry is to:
deploy the defined target system objects at the target system to determine if the defined target system objects are included in the target system; and
when the defined target system objects do not exist at the target system, create new instances of the defined target system objects at the target system.

8. A non-transitory computer readable storage medium comprising instructions that, when executed, cause one or more processors to at least:
generate model definitions representative of one or more undefined target system objects in a target system;
generate instructions that cause a developer environment to provide the model definitions during a generation of content files;
generate a processing order of the content files, the content files having one or more defined model objects; and
convert the one or more defined model objects to defined target system objects for deployment and execution at the target system.

9. The non-transitory computer readable storage medium of claim 8, wherein the instructions, when executed, cause the one or more processors to identify extensible model objects based on previously defined relationships between previous target system objects.

10. The non-transitory computer readable storage medium of claim 8, wherein the instructions, when executed, cause the one or more processors to add extensible undefined model objects to the model definitions, the extensible undefined model objects to extend a capability of the model definitions.

11. The non-transitory computer readable storage medium of claim 8, wherein the instructions, when executed, cause the one or more processors to configure policies corresponding to tightly coupled undefined model objects, the policies to guide a generation of model objects at the developer environment.

12. The non-transitory computer readable storage medium of claim 11, wherein the instructions, when executed, cause the one or more processors to generate policy-based instructions based on the policies corresponding to tightly coupled model objects, the policy-based instructions to cause the developer environment to add extensibility to model definitions.

13. The non-transitory computer readable storage medium of claim 8, wherein the instructions, when executed, cause the one or more processors to determine the processing order of the content files based on respective labels of the content files, wherein a first respective label having a lowest numerical value in the first respective label is to be processed first and a second respective label having a second lowest numerical value in the second respective label is to be processed second.

14. The non-transitory computer readable storage medium of claim 8, wherein the instructions, when executed, cause the one or more processors to:
deploy the defined target system objects at the target system to determine if the defined target system objects are included in the target system; and
when the defined target system objects do not exist at the target system, create new instances of the defined target system objects at the target system.

15. An apparatus comprising:
at least one memory;
computer readable instructions; and
processor circuitry to execute the instructions to at least:
create model definitions representative of one or more undefined target system objects in a target system;
generate instructions that cause a developer environment to provide the model definitions during a generation of content files;
generate a processing order of the content files, the content files having one or more defined model objects; and
convert the one or more defined model objects to defined target system objects for deployment and execution at the target system.

16. The apparatus of claim 15, wherein the processor circuitry is to identify extensible model objects based on previously defined relationships between previous target system objects.

17. The apparatus of claim 15, wherein the processor circuitry is to add extensible undefined model objects to the model definitions, the extensible undefined model objects to extend a capability of the model definitions.

18. The apparatus of claim 15, wherein the processor circuitry is to:
configure policies corresponding to tightly coupled undefined model objects, the policies to guide a generation of model objects at the developer environment; and
generate policy-based instructions based on the policies corresponding to tightly coupled model objects, the policy-based instructions to cause the developer environment to add extensibility to model definitions.

19. The apparatus of claim 15, wherein the processor circuitry is to determine the processing order of the content files based on respective labels of the content files, wherein a first respective label having a lowest numerical value in the first respective label is to be processed first and a second respective label having a second lowest numerical value in the second respective label is to be processed second.

20. The apparatus of claim 15, wherein the processor circuitry is to:
deploy the defined target system objects at the target system to determine if the defined target system objects are included in the target system; and
when the defined target system objects do not exist at the target system, create new instances of the defined target system objects at the target system.
